(19) United States
(12) Patent Application Publication
(10) Pub. No.: US 2017/0155325 A1
(43) Pub. Date: Jun. 1, 2017

(54) RESONANT POWER SUPPLY DEVICE

(71) Applicant: Hitachi Information & Telecommunication Engineering, Ltd., Yokohama-shi (JP)

(72) Inventors: Takae SHIMADA, Tokyo (JP); Yuki KAWAGUCHI, Tokyo (JP); Fumikazu TAKAHASHI, Yokohama (JP); Kimiaki TANIGUCHI, Yokohama (JP); Kosuke ABE, Yokohama (JP)

(21) Appl. No.: 15/346,970

(22) Filed: Nov. 9, 2016

(30) Foreign Application Priority Data
Nov. 26, 2015 (JP) 2015-230426

(51) Int. Cl. H02M 3/335; H02J 50/12; H05B 6/04; H02M 1/08

(52) U.S. Cl. CPC H02M 3/335; H02M 1/08; H02J 50/12; H05B 6/04; H02M 2001/0048

(57) ABSTRACT

A resonant power supply includes a full bridge circuit having a first switching leg and a second switching leg and a control unit that controls operations of a first upper arm switching device and a first lower arm switching device constituting the first switching leg, and a second upper arm switching device and a second lower arm switching device constituting the second switching leg and feeds power to a load from a DC power supply via the full bridge circuit. The control unit controls the full bridge circuit so as to have a phase difference between a turn-off of the first upper arm switching device and the turn-off of the second lower arm switching device, and increases the phase difference in accordance with increase of a switching frequency of the full bridge circuit.

### CLAIM OF PRIORITY

The present application claims priority from Japanese application serial no. 2015-230426, filed on Nov. 26, 2015, the content of which is hereby incorporated by reference into this application.

### BACKGROUND OF THE INVENTION

Field of the Invention

The present invention relates to a resonant power supply supplying electric power of DC power supply to a load.

Background Art

In recent years, from growing awareness of global environmental conservation, a system that is equipped with a DC power supply such as a storage battery or a solar cell, a fuel cell is developed. In these systems, a DC-DC converter is required for feeding power at high conversion efficiency to a load or another DC power supply from the DC power supply. As a circuit type of an insulated DC-DC converter with high efficiency, a resonant converter is known which utilizes a resonance phenomenon between a capacitance and an inductance.

In the resonant converter, when a switching device is turned off at the timing when a current flowing through a switching device is decreased by a resonance, since a turn-off current is small, switching loss is decreased. Therefore, the high efficiency may be obtained. However, in general, since the output is controlled by changing a switching frequency and the switching frequency is increased when reducing output electric power in the resonant converter, in a case where an input voltage is high or in a case where an output voltage is low, the switching frequency is increased. Then, the switching device becomes to be turned off before the current flowing through the switching device is decreased by the resonance. If an output current is large at this time, since the turn-off current is large and the switching frequency also is high, the switching loss is increased and the efficiency is decreased.

On the other hand, by phase control of the inverter unit in the resonant DC-DC converter, the related art in which a control range of the output electric power extends without changing a switching operation frequency is known (For example, refer to JP-A-2010-11625 and JP-A-63-190556).

According to the above-described related art, output electric power may be controlled without changing a switching frequency. However, in a case where a ratio between the input and output voltages (value obtained by dividing an output voltage by an input voltage) is decreased in a state where an output current is large, that is, in a case where the input voltage is increased or the output voltage is decreased, since a peak value of a current waveform flowing through a switching device or a winding of a transformer increases and a current effective value increases, there is a problem that conduction loss is increased so that efficiency is likely to be decreased.

### SUMMARY OF THE INVENTION

The invention provides a resonant power supply in which the output current is large and the high efficiency may be obtained even in a case where the ratio between the input and output voltages is small.

In order to solve the above-described problem, according to the invention, there is provided a resonant power supply including a full bridge circuit having a first switching leg and a second switching leg and a control unit that controls operations of a first upper arm switching device and a first lower arm switching device constituting the first switching leg, and a second upper arm switching device and a second lower arm switching device constituting the second switching leg, and feeds power to a load from a DC power supply via the full bridge circuit. The control unit controls the full bridge circuit so as to have a phase difference between a turn-off of the first upper arm switching device and the turn-off of the second lower arm switching device, and increases the phase difference in accordance with increase of a switching frequency of the full bridge circuit.

The phase difference between the turn-off of the first upper arm switching device and the turn-off of the second lower arm switching device is increased in accordance with the increase of the switching frequency. Therefore, loss is decreased and the efficiency is improved.

Other objects, features, and advantages of the invention will appear from the following description with the accompanying drawings.

### BRIEF DESCRIPTION OF THE DRAWINGS

FIG. 1 is a circuit diagram of a resonant power supply according to Example 1.

FIG. 2A is an operation diagram illustrating a step-up operation of the resonant power supply according to Example 1.

FIG. 2B is an operation diagram illustrating the step-up operation of the resonant power supply according to Example 1.

FIG. 2C is an operation diagram illustrating the step-up operation of the resonant power supply according to Example 1.

FIG. 2D is an operation diagram illustrating the step-up operation of the resonant power supply according to Example 1.

FIG. 3A is an operation diagram illustrating a step-down operation of the resonant power supply according to Example 1.

FIG. 3B is an operation diagram illustrating the step-down operation of the resonant power supply according to Example 1.

FIG. 3C is an operation diagram illustrating the step-down operation of the resonant power supply according to Example 1.

FIG. 3D is an operation diagram illustrating the step-down operation of the resonant power supply according to Example 1.

FIG. 3E is an operation diagram illustrating the step-down operation of the resonant power supply according to Example 1.

FIG. 4A is an operation diagram illustrating a step-down operation of the resonant power supply according to Example 1.

FIG. 4B is an operation diagram illustrating the step-down operation of the resonant power supply according to Example 1.

FIG. 4C is an operation diagram illustrating the step-down operation of the resonant power supply according to Example 1.

FIG. 4D is an operation diagram illustrating the step-down operation of the resonant power supply according to Example 1.

FIG. 4E is an operation diagram illustrating the step-down operation of the resonant power supply according to Example 1.

FIG. 5 is an operation waveform diagram of the resonant power supply according to Example 1.

FIG. 6 is an operation waveform diagram of the resonant power supply according to Example 1.

FIG. 7 is an operation waveform diagram of the resonant power supply according to Example 1.

FIG. 8 is an operation waveform diagram of the resonant power supply according to Example 1.

FIG. 9 illustrates relationship between a switching frequency and phase difference in Example 1.

FIG. 10 is a circuit diagram of a resonant power supply according to Example 2.

FIG. 11 illustrates a contactless power supply which is Example 3 according to the invention.

FIG. 12 illustrates an induction heater which is Example 4 according to the invention.

### DETAILED DESCRIPTION OF THE INVENTION

Hereinafter, an embodiment of the invention will be described in detail with reference to drawings. In each drawing, those of which reference numerals are identical indicate the same configuration requirements or the configuration requirements having similar functions.

### EXAMPLE 1

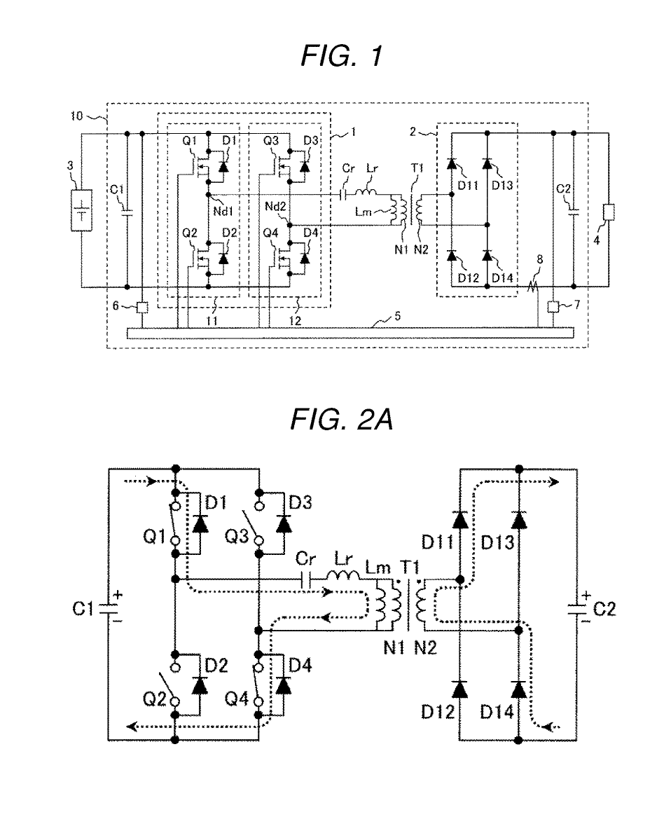

FIG. 1 is a circuit diagram of a resonant power supply 10 which is Example 1 according to the invention. The resonant power supply 10 is connected between a DC power supply 3 and a load 4 and performs a power conversion of DC power from the DC power supply 3 to feed power to the load 4.

This resonant power supply 10 is provided with a full bridge circuit 1, a rectifier circuit 2, and a control unit 5 for controlling an on-off state of a switching device in which these circuits are provided. The full bridge circuit 1 connects a switching leg 11 in which an upper arm switching device Q1 and a lower arm switching device Q2 are connected in series at a node Nd1 and a switching leg 12 in which an upper arm switching device Q3 and a lower arm switching device Q4 are connected in series at a node Nd2 in parallel. The full bridge circuit 1 sets between both ends of the switching legs 11 and 12 to an input of the full bridge circuit 1, and sets the nodes Nd1 and Nd2 to an output of the full bridge circuit 1. The full bridge circuit 1 operates as an inverter circuit.

A smoothing capacitor C1 is connected to the input of the full bridge circuit 1. A resonance capacitor Cr, a resonance inductor Lr, and a winding N1 of a transformer T1 are connected in series to the output of the full bridge circuit 1. Furthermore, in FIG. 1, excitation inductance Lm is connected to the winding N1 in parallel, as an equivalent circuit element in which an excitation current of the transformer T1 flows.

Here, in the resonant power supply 10 according to Example 1, the resonance capacitor Cr and the resonance inductor Lr may exist between the output of the full bridge circuit land the smoothing capacitor C2, for example, may insert the resonance inductor Lr into the winding N2 in series. A leakage inductance of the transformer T1 may be utilized as the resonance inductor Lr.

The winding N2 magnetically coupled to the winding N1 is connected to the input of the rectifier circuit 2 bridge-connecting diodes D11 to D14, and the smoothing capacitor C2 is connected to the output of the rectifier circuit 2. The DC power supply 3 is connected to the smoothing capacitor C1 in parallel, and the load 4 is connected to the smoothing capacitor C2 in parallel. The resonant power supply 10 outputs electric power inputted from both ends of the smoothing capacitor C1 to both ends of the smoothing capacitor C2.

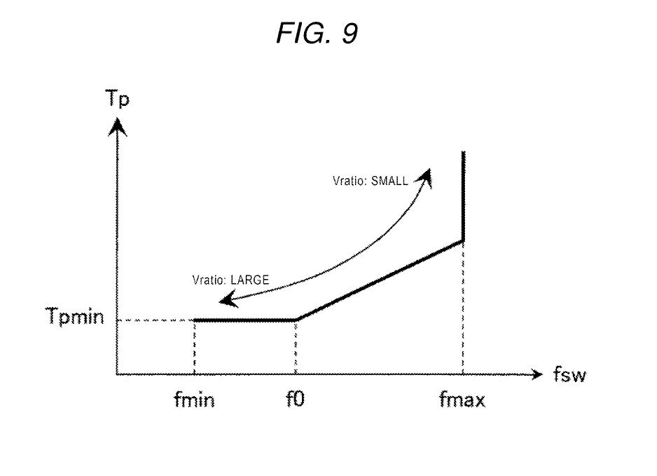

A voltage sensor 6 is connected to the smoothing capacitor C1, and detects an input voltage of the full bridge circuit 1. A voltage sensor 7 is connected to the smoothing capacitor C2, and detects an output voltage of the rectifier circuit 2. A current sensor 8 is connected to the smoothing capacitor C2, and detects an output current of the rectifier circuit 2. These voltage sensors 6 and 7 and the current sensor 8 are connected to the control unit 5. The control unit 5 creates a gate drive signal of the switching devices Q1 to Q4, on the basis of these sensor signals and relationship between phase difference and a switching frequency of turn-off timing between the switching devices (FIG. 9) described later. The control unit 5 is configured of an arithmetic processing device such as a micro computer, a known pulse width modulation (PWM) circuit and a gate drive circuit. The arithmetic processing device creates a control command signal by executing a predetermined program, and the gate drive circuit outputs the gate drive signal in accordance with the PWM signal which the PWM circuit creates on the basis of the control command signal.

The diodes D1 to D4 are respectively connected to the switching devices Q1 to Q4 in reverse parallel. The diodes D1 to D4 operate as freewheeling diode. Here, in Example 1, since a MOSFET is used as the switching devices Q1 to Q4, a parasitic diode of a MOSFET can be utilized instead of the diodes D1 to D4. In this case, individual diodes D1 to D4 can be omitted.

Hereinafter, operation of the resonant power supply 10 according to Example 1 will be described with reference to drawings. In the following description, a value obtained by dividing the output voltage of the resonant power supply 10 by the input voltage is defined as a ratio between the input and output voltages, a resonant frequency according to the resonance inductor Lr and the resonance capacitor Cr is defined as the LrCr resonant frequency f0. The voltage of both ends of the switching device in the ON state or the voltage approximately equal to or equal to or less than a forward drop voltage of the diode is referred to as a zero voltage. When the voltage of both ends of the switching device is the zero voltage, turning on this switching device is referred to as a zero voltage switching. According to the zero voltage switching, switching loss occurring in the switching device can be suppressed.

### Step-Up Operation

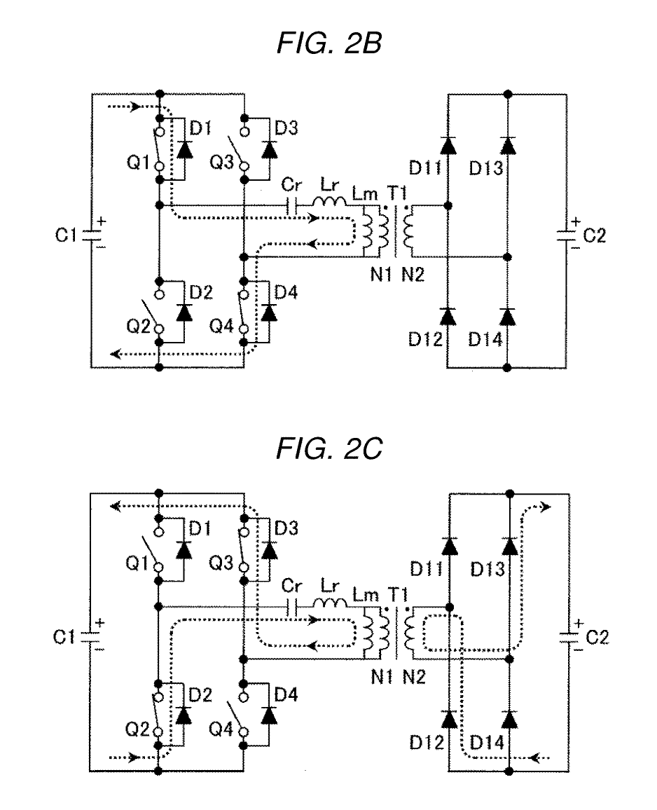

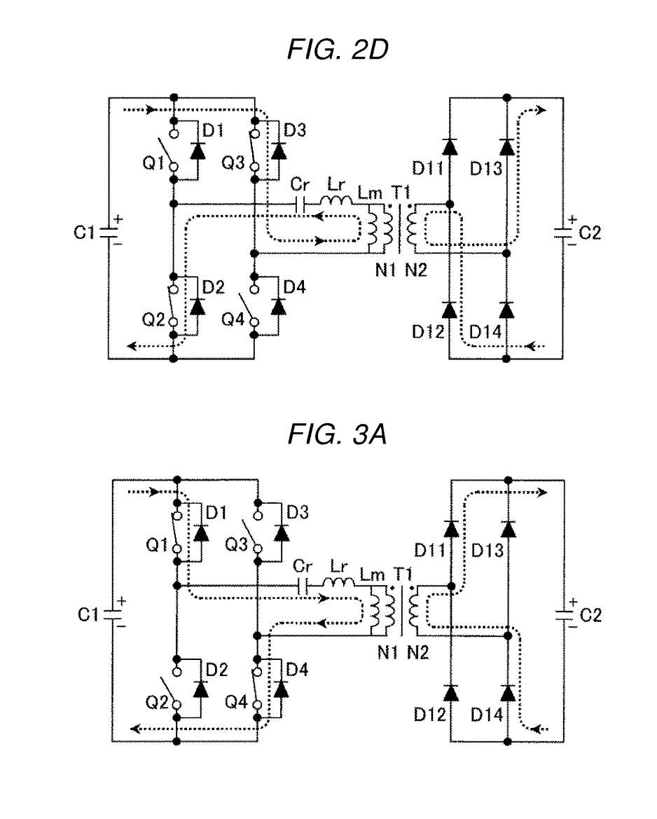

With reference to FIGS. 2A to 2D, a step-up operation of the resonant power supply 10 will be described. In the step-up operation, the switching frequency fsw of the full bridge circuit 1 (switching devices Q1 to Q4) is lowered than the LrCr resonant frequency f0. Thereby, the ratio between the input and output voltages can be increased by the resonances between the resonance capacitor Cr and the excitation inductance Lm.

FIGS. 2A to 2D are operation diagrams respectively illustrating a circuit operation in modes 2A to 2D. Since the resonant power supply 10 operates in the order of the modes 2A to 2D, hereinafter, it will be described in the order of operation.

### Mode 2A

In the mode 2A, the switching devices Q1 and Q4 are in the on state, and the switching devices Q2 and Q3 are in the off state. The voltage of the smoothing capacitor C1 is output from the full bridge circuit 1, and is applied to the resonance capacitor Cr, the resonance inductor Lr, and the winding N1. The current flows through the resonance capacitor Cr, the resonance inductor Lr, and the winding N1. The current induced in the winding N2 passes through the diodes D11 and D14, and flows to both ends of the smoothing capacitor C2.

### Mode 2B

When a charge is accumulated in the resonance capacitor Cr and a resonant current by the resonance capacitor Cr and the resonance inductor Lr finishes flowing, it becomes a state of the mode 2B. The excitation current of the transformer T1 flows through the resonance capacitor Cr, the resonance inductor Lr, and the winding N1 (excitation inductance Lm). This current is the resonant current by the resonance capacitor Cr, the resonance inductor Lr, and the excitation inductance Lm. The voltage of the winding N2 is lower than the voltage of the smoothing capacitor C2 of the output, and the current does not flow through the winding N2.

### Mode 2C

When the switching devices Q1 and Q4 are turned off, it becomes a state of the mode 2C. The current flowing through the switching devices Q1 and Q4 is commutated to the diodes D2 and D3, and flows to the smoothing capacitor C1. At this time, the switching devices Q2 and Q3 are turned on (zero voltage switching). The voltage of the smoothing capacitor C1 is applied to the resonance capacitor Cr, the resonance inductor Lr, and the winding N1 (excitation inductance Lm) in the opposite direction to the mode 2A, and the current of the winding N1 is decreased. The voltage is applied to the winding N1, the current induced in the winding N2 passes through the diodes D12 and D13, and flows to both ends of the smoothing capacitor C2.

### Mode 2D

When the current of the winding N1 is reversed, it becomes a state of the mode 2D. This mode 2D is a symmetrical operation of the mode 2A. Hereinafter, the mode 2D returns to the mode 2A after the symmetrical operation of the mode 2B and the mode 2C.

### Step-Down Operation 1

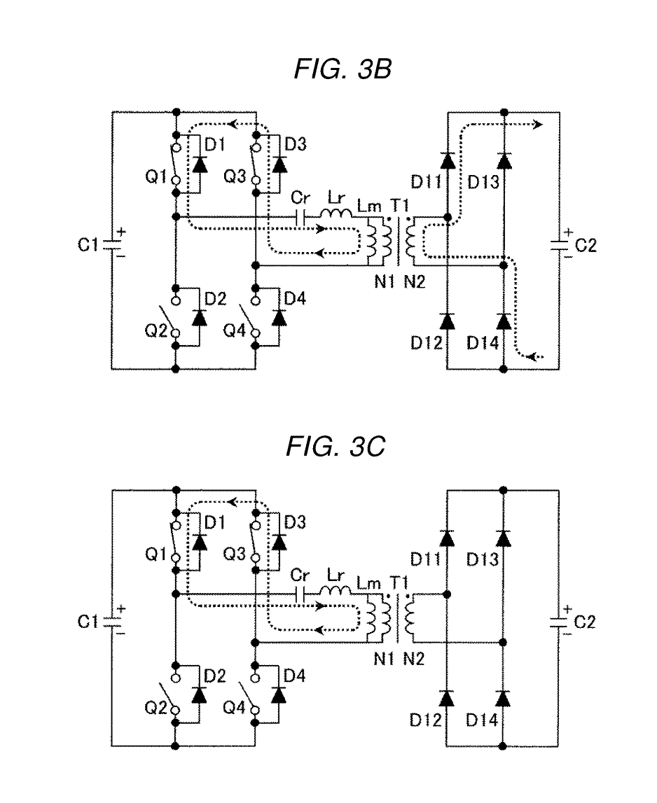

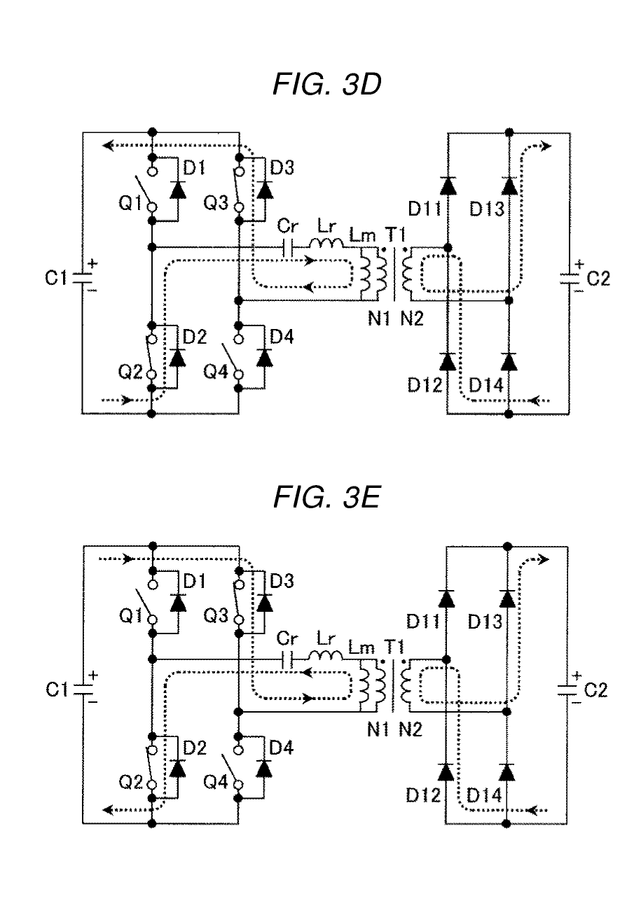

Next, the step-down operation 1 of the resonant power supply 10 will be described with reference to FIGS. 3A to 3E. In this step-down operation 1, the switching frequency fsw of the full bridge circuit 1 (switching devices Q1 to Q4) is set higher than the LrCr resonant frequency f0. The resonant current by the resonance capacitor Cr and the resonance inductor Lr is turned off by the switching device provided in the full bridge circuit 1. Therefore, the ratio between the input and output voltages can be lowered.

FIGS. 3A to 3E are operation diagrams respectively illustrating a circuit operation in the modes 3A to 3E.

Since the resonant power supply 10 operates in the order of the modes 3A to 3E, hereinafter, it will be described in the order of operation.

### Mode 3A

The mode 3A is similar to the mode 2A (FIG. 2A) of the step-up operation.

### Mode 3B

When the switching device Q4 is turned off, the current flowing through the switching device Q4 is commutated to the diode D3 and it becomes a state of the mode 3B. At this time, the switching device Q3 is turned on (zero voltage switching). The output voltage of the inverter circuit 1 becomes the zero voltage, the current flowing through the switching device Q1, the resonance capacitor Cr, the resonance inductor Lr, and the winding N1 is decreased, and the current flowing through the winding N2 also is decreased.

### Mode 3C

When the current of the winding N2 is decreased to zero, it becomes a state of the mode 3C. The excitation current of the transformer T1 flows through the switching device Q1, the resonance capacitor Cr, the resonance inductor Lr, and the winding N1 (excitation inductance Lm).

### Mode 3D

When the switching device Q1 is turned off, the current flowing through the switching device Q1 is commutated to the diode D2 and it becomes a state of the mode 3D. At this time, the switching device Q2 is turned on (zero voltage switching). The operation of this mode 3D is similar to the mode 2C (FIG. 2C) of the step-up operation.

### Mode 3E

The mode 3E is similar to the mode 2D (FIG. 2D) of the step-up operation. This mode 3E is a symmetrical operation of the mode 3A. Hereinafter, the mode 3E returns to the mode 3A after the symmetrical operation of the modes 3B to 3D.

### Step-Down Operation 2

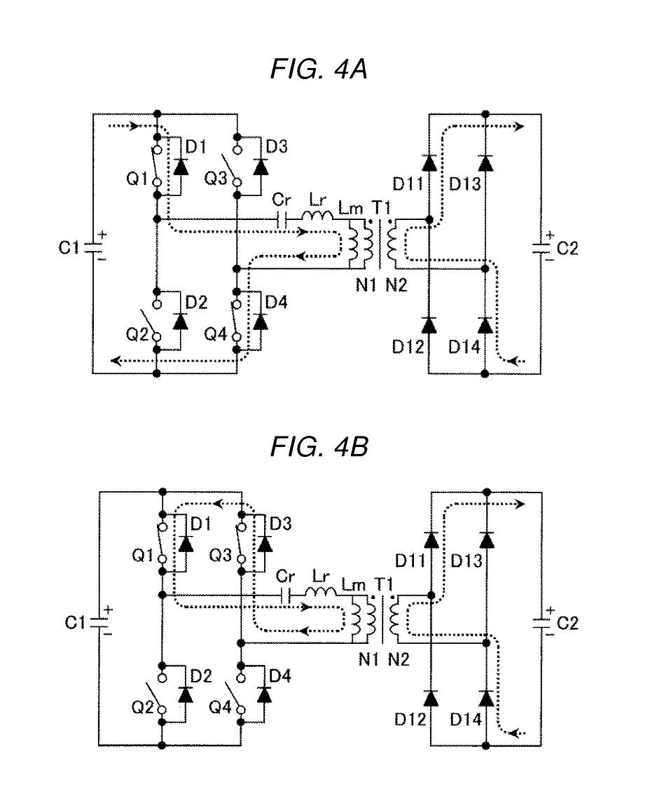

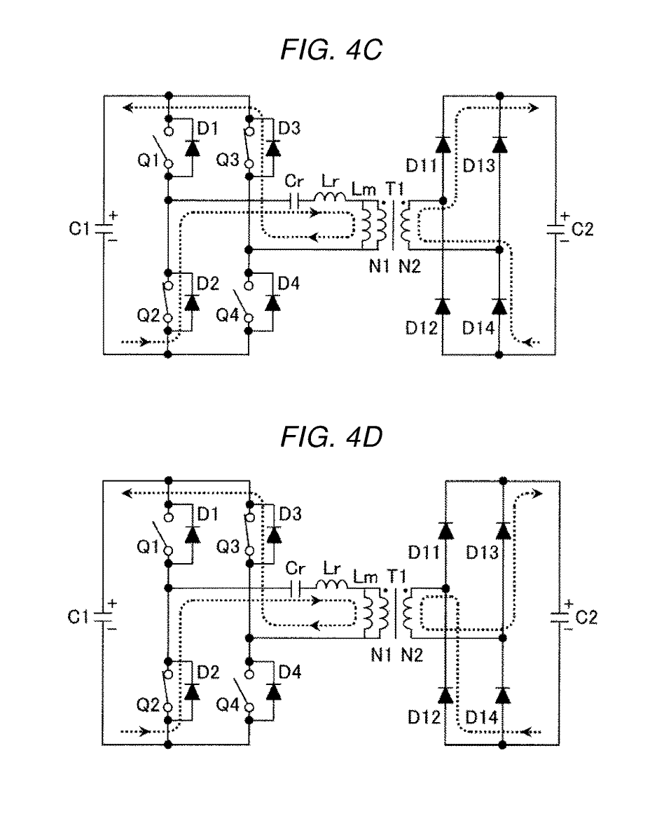

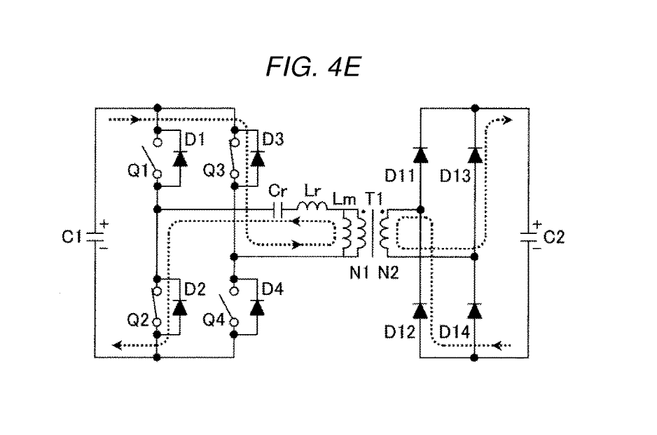

Next, the step-down operation 2 of the resonant power supply 10 will be described with reference to FIGS. 4A to 4E. In this step-down operation 2, the switching frequency fsw is set higher than the LrCr resonant frequency f0 similar to the step-down operation 1 and the ratio between the input and output voltages is lowered.

FIGS. 4A to 4E are operation diagrams respectively illustrating a circuit operation in the modes 4A to 4E.

Since the resonant power supply 10 operates in the order of the modes 4A to 4E, hereinafter, it will be described in the order of operation.

### Modes 4A and 4B

The modes 4A and 4B are similar to the mode 3A (FIG. 3A) and 3B (FIG. 3B) of the step-down operation 1.

### Mode 4C

When the switching device Q1 is turned off, it becomes a state of the mode 4C. The current flowing through the switching device Q1 is commutated to the diode D2, and flows to the smoothing capacitor C1. At this time, the switching device Q2 is turned on (zero voltage switching). The voltage of the smoothing capacitor C1 is applied to the resonance capacitor Cr, the resonance inductor Lr, and the winding N1 (excitation inductance Lm) in the opposite direction to the mode 4A, and the current of the windings N1 and N2 is rapidly decreased.

### Mode 4D

When the current of the winding N2 is decreased to zero, it becomes a state of the mode 4D. The current of the winding N2 is increased in the opposite direction, and this current passes through the diodes D12 and D13 to flow to both ends of the smoothing capacitor C2. Mode 4E

The mode 4E is similar to the mode 3E (FIG. 3E) of the step-down operation 1. This mode 4E is a symmetrical operation of the mode 4A. Hereinafter, the mode 4E returns to the mode 4A after the symmetrical operation of the modes 4B to 4D.

In a typical resonant converter according to the related art, the switching device Q1 and the switching device Q4 are turned off at the same timing in the step-down operation. On the other hand, in the resonant power supply 10 according to Example 1, as described for the step-down operation 1 and the step-down operation 2, a time difference (phase difference) to the turn-off timing of the switching device Q1 and the switching device Q4 is provided. Specifically, the switching device Q4 is turned off earlier than the switching device Q1 and the switching device Q1 is turned off, after the current flowing through the switching device Q1 is decreased. Thereby, since a turn-off current of the switching device Q1 can be decreased, and the switching frequency may also be kept low, the switching loss is decreased and the conversion efficiency is increased.

Next, a difference between the step-down operation 1 and the step-down operation 2 will be described.

The mode 3B (FIG. 3B) of the step-down operation 1 and the mode 4B (FIG. 4B) of the step-down operation 2 are similar to each other. Then, when the switching device Q1 is turned off after the current of the winding N2 reaches zero, it becomes the step-down operation 1, and when the switching device Q1 is turned off before the current of the winding N2 reaches zero, it becomes the step-down operation 2. In a case where the switching device Q1 is turned off at the timing when the current of the winding N2 reaches zero, it is the circuit operation in which the mode 3C (FIG. 3C) of the step-down operation 1 and the mode 4C (FIG. 4C) of the step-down operation 2 are omitted.

Since the turn-off current of the switching device Q1 can be decreased by the step-down operation 1 which increases the phase difference between the turn-off timing of the switching device Q1 and that of the switching device Q4 rather than by the step-down operation 2, the switching loss of the switching device Q1 can be decreased by the step-down operation 1. However, when the period of the mode 3C is longer in the step-down operation 1, since the peak value of the current flowing through the switching devices Q1 to Q4, the resonance inductor Lr, and the windings N1 and N2 are increased, and the current effective value is increased, conduction loss is increased. Although the conduction loss of the step-down operation 2 which decreases the phase difference between the turn-off timing of the switching device Q1 and that of the switching device Q4 is smaller than that of the step-down operation 1, the switching loss of the step-down operation 2 is increased. Accordingly, it is preferable to operate the switching device Q1 with the phase difference to the extent of turning off the switching device Q1 substantially at the timing when the current of the winding N2 reaches zero, that is, at the timing when the current of the resonant inductor Lr is equal to the excitation current of the transformer T1, so as to obtain the high efficiency.

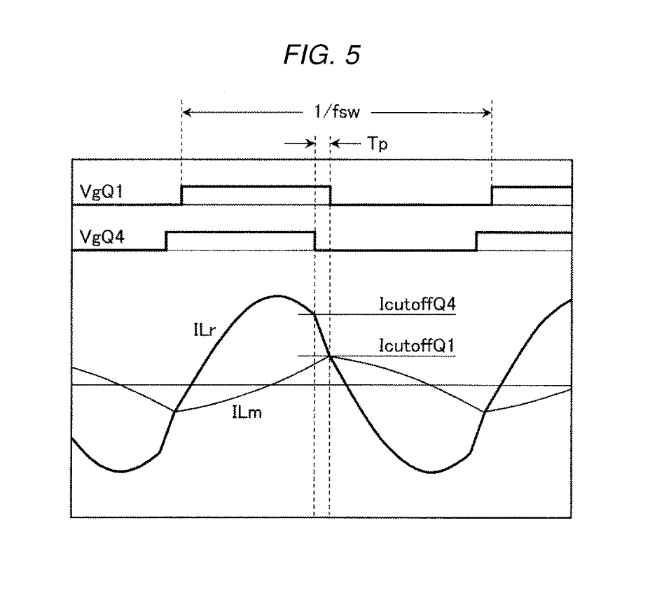

Next, with reference to the operation waveform of FIGS. 5 to 8, setting means of the phase difference of the turn-off timing between the switching device Q1 and the switching device Q4 will be described in Example 1. In these drawings, a VgQ1 and a VgQ4 respectively represent a gate signal of the switching devices Q1 and Q4. An ILr indicates the current of the resonance inductor Lr, and an orientation which flows from the node Nd1 to the node Nd2 is set to a positive. An ILm represents the excitation current of the transformer T1 viewed from the winding N1, and an orientation which flows from the resonance inductor Lr is set to a positive. An Icutoff Q1 and an Icutoff Q4 respectively represent the turn-off current of the switching devices Q1 and Q4. An 1/fsw represents a reciprocal, that is, a switching cycle of the switching frequency fsw, and a Tp represents the phase difference of the turn-off timing between the switching device Q1 and the switching device Q4.

FIG. 5 indicates the operation waveform in a certain input and output voltage and current conditions. It is the step-down operation which turns off the resonant current by the resonance capacitor Cr and the resonance inductor Lr. The switching device Q4 is turned off previously and at the timing when the current ILr of the resonance inductor Lr is substantially equal to the excitation current ILm of the transformer T1, the switching device Q1 is turned off. Thereby, the turn-off current Icutoff Q1 of the switching device Q1 is decreased rather than the turn-off current Icutoff Q4 of the switching device Q4.

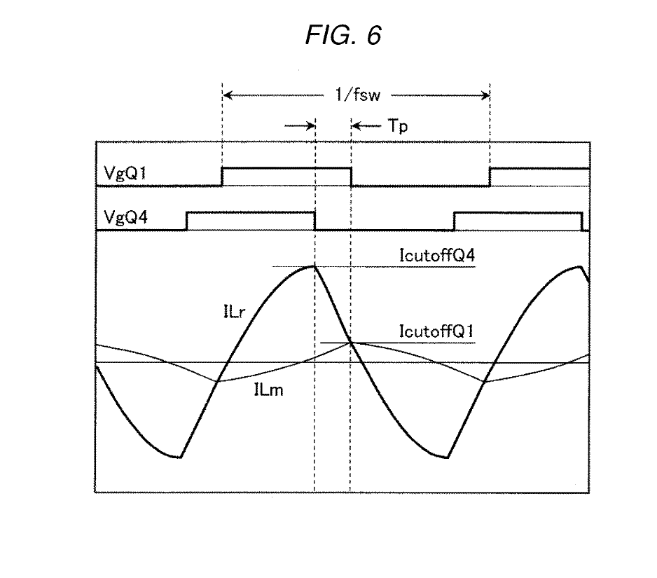

FIG. 6 indicates the operation waveform under the condition in which the output voltage is decreased with the same output current as in FIG. 5. Since the ratio between the input and output voltages in FIG. 6 is lower than that in FIG. 5, the switching frequency fsw is high. For this reason, the switching cycle 1/fsw is shortened, the turn-off current Icutoff Q4 of the switching device Q4 is increased. As is clear in FIG. 5 and FIG. 6, even in a case where the switching frequency fsw is high, in order to turn off the switching device Q1 at the timing when the current ILr of the resonance inductor Lr is substantially equal to the excitation current ILm of the transformer T1, the phase difference Tp is increased in accordance with the rise of the switching frequency fsw. Even in a case where the input voltage is increased, since the switching frequency fsw increases, the phase difference Tp is increased.

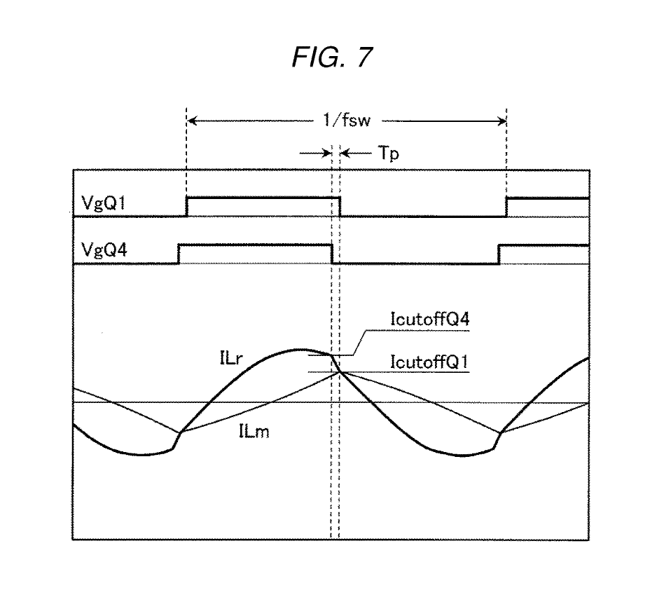

FIG. 7 indicates the operation waveform under the condition in which the output current is decreased with the same switching frequency fsw as in FIG. 5. The turn-off current Icutoff Q4 of the switching device Q4 in FIG. 7 is decreased rather than that in FIG. 5. For this reason, as is clear in FIG. 5 and FIG. 7, even in a case where the output current is decreased, in order to turn off the switching device Q1 at the timing when the current ILr of the resonance inductor Lr is substantially equal to the excitation current ILm of the transformer T1, the phase difference Tp is decreased in accordance with the reduction of the output current.

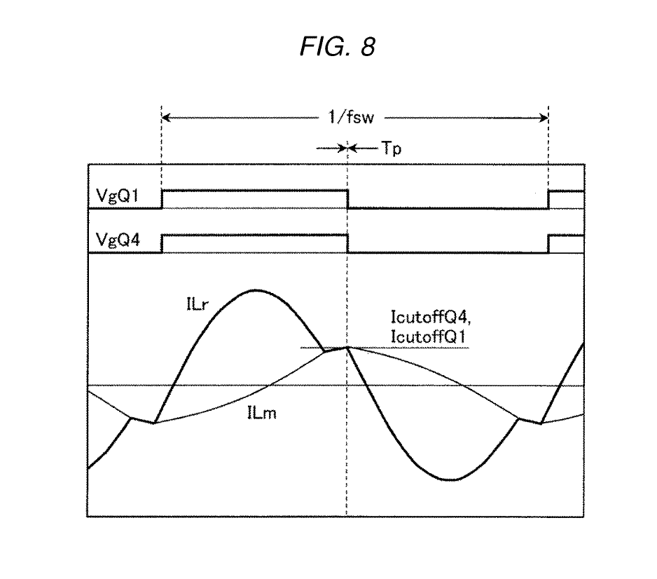

FIG. 8 indicates the operation waveform under the condition in which the output voltage is increased with the same output current as in FIG. 5. Since the ratio between the input and output voltages is high in FIG. 8, it is the step-up operation in which the switching frequency fsw is lower than the LrCr resonant frequency f0. The phase difference Tp is minimized and, the switching devices Q1 and Q4 are turned off at the same timing, and the turn-off currents Icutoff Q1 and Icutoff Q4 are both equal to the excitation current ILm. A value greater than zero may be set as the lower limit value of the phase difference Tp in this step-up operation.

FIG. 9 illustrates relationship between the switching frequency fsw and the phase difference Tp in Example 1. The “fmin” represents the lower limit value of the switching frequency fsw, the “fmax” represents the upper limit value of the switching frequency fsw, the “Tpmin” represents the lower limit value of the phase difference Tp, and the “Vratio” represents the ratio between the input and output voltages in FIG. 9.

First, when the ratio between the input and output voltages Vratio is large, the switching frequency fsw is lower than the LrCr resonant frequency f0 and is operated in the step-up operation. At this time, the phase difference Tp is set to the lower limit value Tpmin. When the ratio between the input and output voltages Vratio decreases, the switching frequency fsw is higher than the LrCr resonant frequency f0 to be the step-down operation. At this time, the phase difference Tp is set to be increased in accordance with the rise of the switching frequency fsw. Furthermore, when the ratio between the input and output voltages Vratio decreases, the switching frequency fsw is fixed to the upper limit value fmax, and the operation causes the phase difference Tp to increase so that the output is reduced. In this manner, by setting the phase difference Tp, the resonant power supply 10 according to Example 1 reduces the switching loss while suppressing the increase of the conduction loss for a wide range of the voltage. Therefore, the high efficiency may be obtained.

In the description of the circuit operation described above, although the switching device Q4 is turned off previously than the switching device Q1, if the switching device Q1 is turned off previously on the contrary, the turn-off current of the switching device Q4 can be decreased. By a method such as alternately or periodically replacing the switching device to be turned off previously, the loss of the switching device Q1 and the loss of the switching device Q4 may be evenly allocated.

Although the rectifier circuit 2 is configured with the bridge-connected diode in Example 1, changing to another rectifier circuit system such as a voltage doubler rectifier (half-bridge) circuit or a center tap (push-pull) circuit may obtain the same effect as in Example 1.

### EXAMPLE 2

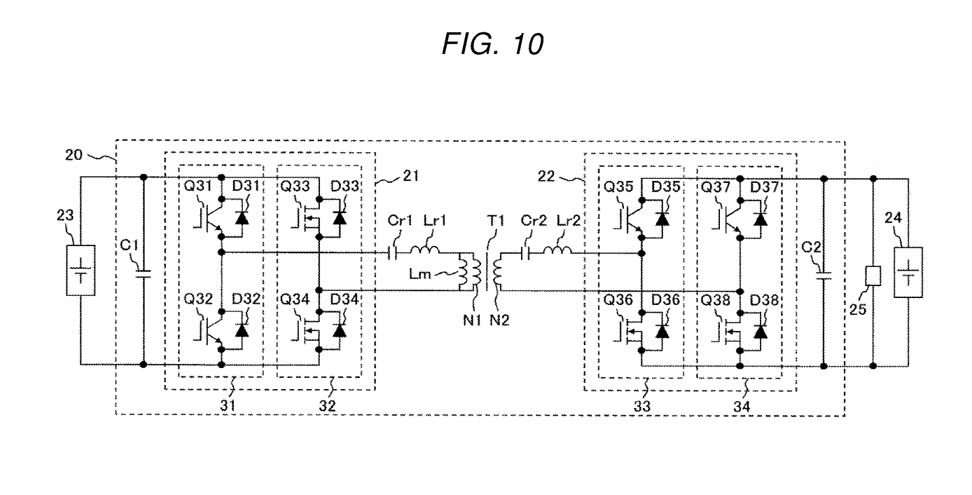

FIG. 10 is a circuit diagram of the resonant power supply 20 which is Example 2 according to the invention. The resonant power supply 20 is provided with a function of power conversion bidirectionally, feeds power from the DC power supply 23 to the DC power supply 24 or the load 25, and feeds power from the DC power supply 24 to the DC power supply 23.

The resonant power supply 20 is different from the resonant power supply 10 according to Example 1, and the winding N2 is connected to the resonance capacitor Cr2 and the resonance inductor Lr2. In the resonant power supply 20, the rectifier circuit 2 which is connected between the winding N2 and the smoothing capacitor C2 in the resonant power supply 10 is changed to the full bridge circuit 22. Thereby, the bidirectional power conversion is possible.

The full bridge circuit 21 uses an IGBT as the switching devices Q31 and Q32 constituting the switching leg 31, and uses a MOSFET as the switching devices Q33 and Q34 constituting the switching leg 32.

Generally, although the IGBT is inexpensive as compared with the MOSFET, the switching loss during the turn-off is large. Accordingly, in the resonant converter according to the related art, the turn-off current of the switching device constituting the full bridge circuit during the step-down operation is large. Therefore, if the IGBT as the switching element is used, the switching loss becomes large.

On the other hand, in the resonant power supply 20 according to Example 2, in a case of feeding power from the DC power supply 23 to the DC power supply 24, the phase difference is provided in the operations of the switching leg 31 and the switching leg 32, the switching devices Q33 and Q34 are turned off previously, and the switching devices Q31 and Q32 are turned off after the current flowing through the switching devices Q31 and Q32 is decreased. At this time, the phase difference is increased in accordance with the rise of the switching frequency. Thereby, since the breaking current of the switching devices Q31 and Q32 may be suppressed while suppressing the increase of the conduction loss, even when using the inexpensive IGBT as the switching devices Q31 and Q32, the efficiency can be improved.

A switching circuit 22 uses the IGBT as the upper arm switching devices Q35 and Q37, and uses the MOSFET as the lower arm switching devices Q36 and Q38. In a case of feeding power from the DC power supply 24 to the DC power supply 23, the upper arm switching devices Q35 and Q37 are turned off after the lower arm switching devices Q36 and Q38 are turned off previously. Thereby, since the turn-off current of the upper arm switching devices Q35 and Q37 can be suppressed, even when using the inexpensive IGBT as the upper arm switching devices Q35 and Q37, the efficiency can be improved.

Hereinbefore, as described for Examples 1 and 2, the phase difference is provided at the turn-off timing of the switching device included in the full bridge circuit. Thereby, a period in which the output of the full bridge circuit becomes the zero voltage is generated. The period in which the output of the full bridge circuit becomes the zero voltage is long in accordance with the rise of the switching frequency of the full bridge circuit. Thereby, the switching loss is decreased while suppressing the increase of the conduction loss and the high efficiency can be obtained.

### EXAMPLE 3

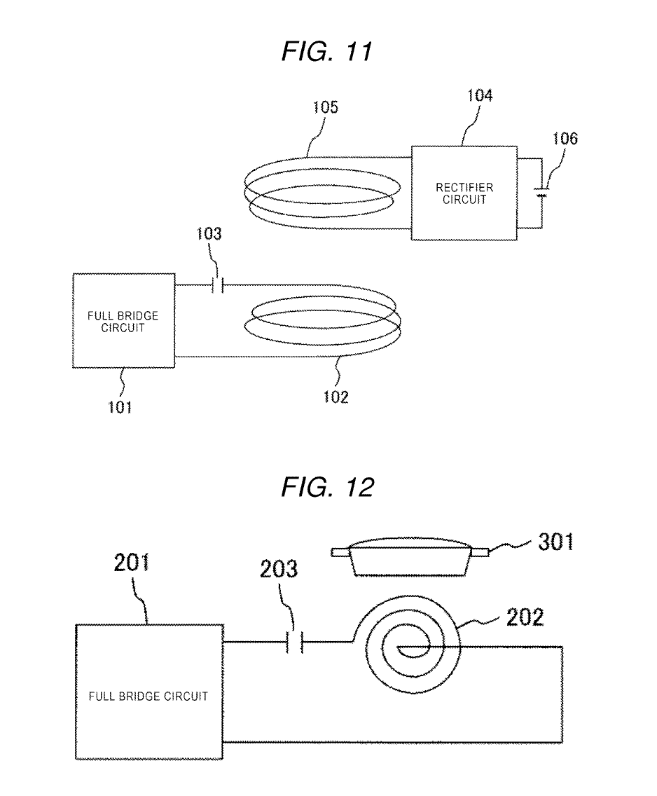

FIG. 11 illustrates a contactless power supply which is Example 3 of the invention.

A resonant circuit configured with a power transmission coil 102 functioning as the resonance inductor and the resonance capacitor 103 is connected to the output of the full bridge circuit 101 provided with the DC power supply (Not illustrated). The full bridge circuit in Example 1 or Example 2 described above is applied as the full bridge circuit 101. If the resonant current flows through the power transmission coil 102 by the full bridge circuit 101, a magnetic flux is generated in the power transmission coil 102. An induced electromotive force generated in a receiving coil 105 by the magnetic flux is converted into DC power by the rectifier circuit 104. A secondary battery 106 is charged by the DC power that the rectifier circuit 104 outputs.

According to Example 3, the full bridge circuit in the above-described Example 1 or Example 2 is applied as the full bridge circuit 101. Therefore, the loss generated in the full bridge circuit 101 is reduced. Thereby, an efficiency of the contactless power supply can be improved.

### EXAMPLE 4

FIG. 12 illustrates an induction heater which is Example 4 of the invention.

A resonant circuit configured with a heating coil 202 functioning as the resonance inductor and the resonance capacitor 203 is connected to the output of the full bridge circuit 201 provided with the DC power supply (not illustrated). The full bridge circuit in Example 1 or Example 2 described above is applied as the full bridge circuit 201. If the resonant current flows through the heating coil 202 by the full bridge circuit 201, the magnetic flux is generated in the heating coil 202. An eddy current flows through a metal heating target mounted on the heating coil 202, that is, a metal pot 301 in this embodiment by the magnetic flux. The metal pot 301 is heated by the eddy current and an electrical resistance of the metal pot 301.

According to Example 4, the full bridge circuit in the above-described Example 1 or Example 2 is applied as the full bridge circuit 201. Therefore, the loss generated in the full bridge circuit 201 is reduced. Thereby, an efficiency of the induction heating device can be improved.

The above-described full bridge circuit in Examples 1 and 2 may be applied to an apparatus supplying the current to the resonant circuit, without limiting to the apparatus in Examples 3 and 4. For example, the full bridge circuit can be widely applied to the resonant power supply using the full bridge circuit, such as the converter that converts the electric power of a solar cell and a fuel cell, the power supply for an information equipment of a server, a charger and a DC-DC converter of an electric car, the power supply for an X-ray tube, the power supply for a laser processing machine, or a bidirectional converter for battery charging and discharging.

The invention is not limited to the above-described examples and includes various modifications. For example, the above-described examples are described in detail in order to easily understand the invention and the invention is not limited to an example essentially including all the configurations described above. Additionally, addition, deletion, or substitution of other configurations may be made to a part of the configuration of each example.

1. A resonant power supply comprising:
a full bridge circuit having a first switching leg and a second switching leg; and
a control unit that controls operations of a first upper arm switching device and a first lower arm switching device constituting the first switching leg, and a second upper arm switching device and a second lower arm switching device constituting the second switching leg,
wherein in the resonant power supply that feeds power to a load from a DC power supply via the full bridge circuit, the control unit controls the full bridge circuit so as to have a phase difference between a turn-off of the first upper arm switching device and the turn-off of the second lower arm switching device, and increases the phase difference in accordance with increase of a switching frequency of the full bridge circuit.

2. The resonant power supply according to claim 1,
wherein in a case where an input voltage of the full bridge circuit is increased, the control unit increases the switching frequency.

3. The resonant power supply according to claim 1,
wherein in a case where an output current of the full bridge circuit is increased while keeping the switching frequency substantially constant, the control unit increases the phase difference.

4. The resonant power supply according to claim 1,
wherein the control unit has an upper limit frequency of the switching frequency, and in a case of increasing the switching frequency to reduce an output of the full bridge circuit, when the switching frequency reaches the upper limit frequency, the control unit increases the phase difference while fixing the switching frequency to the upper limit frequency.

5. The resonant power supply according to claim 1,
wherein the control unit is provided with a lower limit phase difference of the phase difference, and in a case of reducing the switching frequency to increase the output of the full bridge circuit, when the phase difference reaches the lower limit phase difference, the control unit decreases the switching frequency while fixing the phase difference to the lower limit phase difference.

6. The resonant power supply according to claim 1,
wherein between the first upper arm switching device and the second lower arm switching device, a switching device of which a switching loss at the time of turn-off is smaller than that of the switching device to be turned off later is used as the switching device to be turned off previously.

7. The resonant power supply according to claim 6, wherein the switching device to be turned off previously is a MOSFET, and the switching device to be turned off later is an IGBT.

8. The resonant power supply according to claim 1, further comprising:
a first smoothing capacitor connected to an input of the full bridge circuit;
a transformer that has a first winding and a second winding connected to an output of the full bridge circuit;
a rectifier circuit rectifying a current of the second winding;
a second smoothing capacitor connected to an output of the rectifier circuit; and
a resonance capacitor connected between the output of the full bridge circuit and an input of the rectifier circuit.

9. The resonant power supply according to claim 8,
wherein between the first upper arm switching device and the second lower arm switching device, the switching device to be turned off later primarily turns off an excitation current of the transformer.

10. The resonant power supply according to claim 8,
wherein the switching device is provided in parallel with a rectifying device provided in the rectifier circuit, and power is fed from both ends of the second smoothing capacitor to both ends of the first smoothing capacitor.

11. The resonant power supply according to claim 1,
wherein a resonant device including an inductance component and a capacitance component is provided at the output side of the full bridge circuit.

12. The resonant power supply according to claim 11,
wherein the inductance component is a power transmission coil for contactless power supply.

13. The resonant power supply according to claim 11,
wherein the inductance component is a heating coil for induction heating.
